(19) United States
(12) Patent Application Publication
(10) Pub. No.: US 2012/0185654 A1
(43) Pub. Date: Jul. 19, 2012

(54) SEMICONDUCTOR APPARATUS AND SEMICONDUCTOR SYSTEM INCLUDING RANDOM CODE GENERATION CIRCUIT, AND DATA PROGRAMMING METHOD

(75) Inventors: Sang Sik KIM, Ichon-si (KR); Jun Rye Rho, Ichon-si (KR); Sang Chul Lee, Ichon-si (KR)

(73) Assignee: Hynix Semiconductor Inc., Ichon-si (KR)

(21) Appl. No.: 13/194,275

(22) Filed: Jul. 29, 2011

(30) Foreign Application Priority Data
Jan. 13, 2011 (KR) 10-2011-0003607

(51) Int. Cl. G06F 12/00

(52) U.S. Cl. 711/154; 711/E12.001

(57) ABSTRACT

A semiconductor apparatus includes a plurality of linear feedback shift registers configured to receive a plurality of seed codes as initial values and generate respective random codes under a control of a clock signal, a code combination section configured to logically combine the plurality of random codes generated by the plurality of linear feedback shift registers and generate a final random code, and a data conversion unit configured to convert input data based on the final random code and output conversion data.

### CROSS-REFERENCES TO RELATED APPLICATION

The present application claims priority under 35 U.S.C. §119(a) to Korean Application No. 10-2011-0003607, filed on Jan. 13, 2011, in the Korean Intellectual Property Office, which is incorporated herein by reference in its entirety as if set forth in full.

### BACKGROUND

1. Technical Field

Various embodiments of the present invention relate to a semiconductor apparatus and a semiconductor system. In particular, certain embodiments relate to a technology for randomly distributing data programming levels across memory cells by converting input data to conversion data through a random code and programming the conversion data.

2. Related Art

In data programming, a flash memory device of a semiconductor memory apparatus performs a programming operation by adjusting programming levels according to data values. In this case, a specific pattern in the programming levels may cause an occurrence of errors, which has lead to a technology for randomly distributing programming levels.

FIG. 1 is a diagram illustrating a configuration of a semiconductor apparatus which incorporates a random data conversion technology.

Referring to FIG. 1, the semiconductor apparatus may include a linear feedback shift register 1, a data conversion unit 2, and a memory block 3.

The linear feedback shift register 1 receives an input seed code SEED_CODE and a clock signal CLK, and may generate a random code RANDOM_CODE based on the initial seed code SEED_CODE in response to the clock signal CLK.

The data conversion unit 2 receives the RANDOM-CODE generated by the linear feedback shift register 1, and input data INPUT_DATA<7:0>. The data conversion unit 2 converts the input data INPUT_DATA<7:0> based on the random code RANDOM_CODE and outputs conversion data OUTPUT_DATA<7:0>.

The memory block 3 receives the conversion data OUTPUT_DATA<7:0> from the data conversion unit 2, and programs the conversion data OUTPUT_DATA<7:0> to a plurality of memory cells at programming levels corresponding to the conversion data OUTPUT_DATA<7:0>. It is assumed that the memory cell is a NAND flash memory cell.

Meanwhile, after the initial seed code SEED_CODE, a tab, and a length are determined, the linear feedback shift register 1 repeatedly generates a specific sequential code with a predetermined cycle. That is, the linear feedback shift register 1 generates the random code RANDOM_CODE having a same pattern with the start point of the sequential code being repeated based on the initial seed code SEED_CODE. In the case of generating the conversion data OUTPUT_DATA<7:0> using the random code RANDOM_CODE generated by the linear feedback shift register 1 and programming the conversion data OUTPUT_DATA<7:0> to the memory block 3, a period may occur where programming levels are not evenly distributed. Specifically, an outstanding error pattern may occur in the column direction of memory cells arranged in a matrix form, which necessitates a technology for solving the problem.

### SUMMARY

Accordingly, there is a need for an improved random data conversion circuit which reduces the problem of unevenly distributed is programming levels.

To attain the advantages and in accordance with the purposes of the invention, as embodied and broadly described herein, In one embodiment of the present invention, a random code generation circuit includes: a seed code generation section configured to generate a plurality of seed codes having code values corresponding to input addresses; a plurality of linear feedback shift registers configured to receive one of the plurality of seed codes as an initial value and generate respective random codes under a control of a clock signal; and a code combination section configured to logically combine the plurality of random codes generated by the plurality of linear feedback shift registers and generate a final random code.

In another embodiment of the present invention, a semiconductor apparatus includes: a plurality of linear feedback shift registers configured to receive a plurality of seed codes as initial values and generate respective random codes under a control of a clock signal; a code combination section configured to logically combine the plurality of random codes generated by the plurality of linear feedback shift registers and generate a final random code; and a data conversion unit configured to convert input data based on the final random code and output conversion data.

In still another embodiment of the present invention, a semiconductor system including a memory controller and a semiconductor memory apparatus, the memory controller including: a plurality of linear feedback shift registers configured to receive a plurality of seed codes as initial values and generate respective random codes under a control of a clock signal; a code combination section configured to logically combine the plurality of random codes generated by the plurality of linear feedback shift registers and generate a final random code; and a data conversion unit configured to convert input data based on the final random code and output conversion data, wherein the semiconductor memory apparatus is configured to program the conversion data provided from the memory controller at programming levels corresponding to the conversion data.

In still another embodiment of the present invention, a data programming method includes the steps of: generating a plurality of random codes through a plurality of linear feedback shift registers receiving a plurality of seed codes as initial values, respectively; generating a final random code by logically combining the plurality of random codes with each other; generating conversion data by converting input data based on the final random code; and programming the conversion data at programming levels corresponding to the conversion data.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various embodiments consistent with the invention and, together with the description, serve to explain the principles of the invention.

FIG. 1 is a diagram illustrating the configuration of a semiconductor apparatus which incorporates a random data conversion technology;

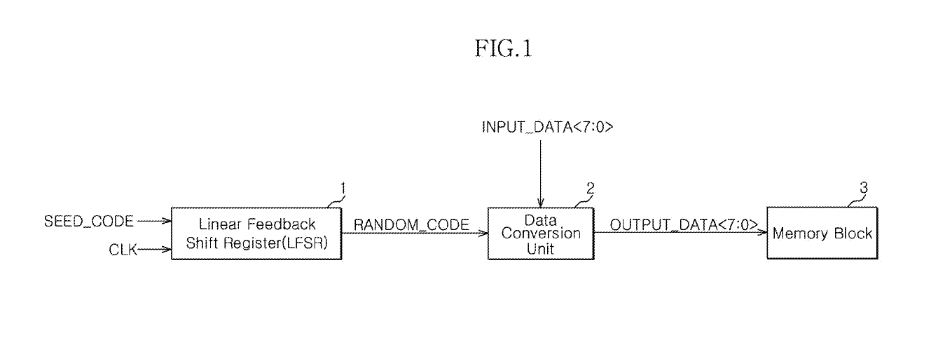

FIG. 2 is a configuration diagram of a semiconductor system according to one exemplary embodiment;

FIG. 3 is a schematic diagram of the seed code generation section illustrated in FIG. 2 according to one exemplary embodiment; to and

FIG. 4 is a configuration diagram of the first linear feedback shift register and the second linear feedback shift register illustrated in FIG. 2 according to one exemplary embodiment.

### DETAILED DESCRIPTION

Reference will now be made in detail to the exemplary embodiments consistent with the present disclosure, examples of which are illustrated in the accompanying drawings. Wherever possible, the same reference characters will be used throughout the drawings to refer to the same or like parts.

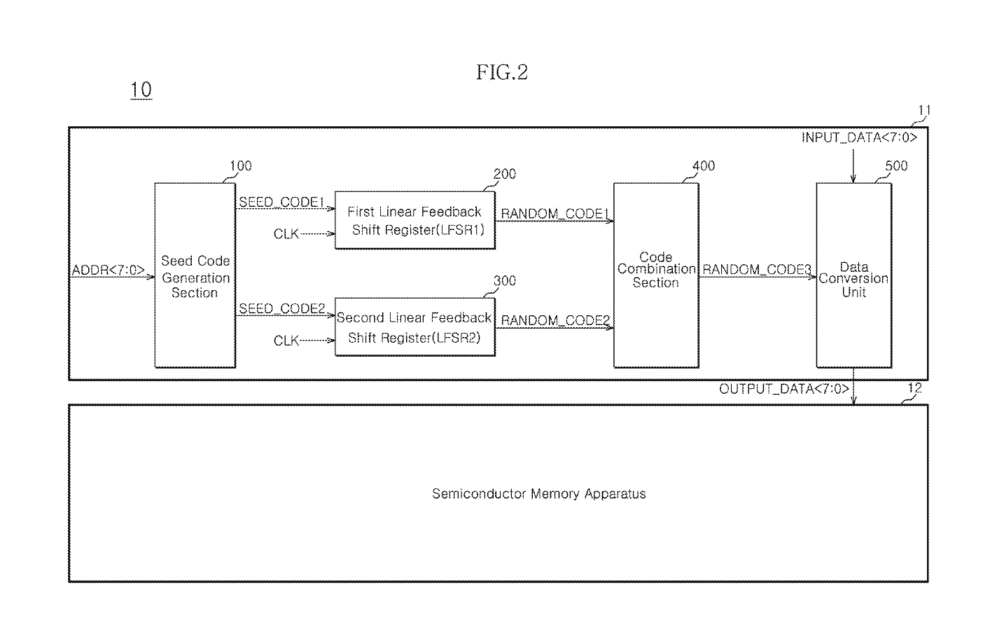

FIG. 2 is a configuration diagram of a semiconductor system according to one exemplary embodiment.

The semiconductor system according to the exemplary embodiment includes only a simplified structure to clearly explain the technical spirit intended to be described herein.

Referring to FIG. 2, a semiconductor system 10 may include a memory controller 11 and a semiconductor memory apparatus 12. The memory controller 11 may be defined as a stand-alone semiconductor apparatus.

The memory controller 11 may include a random code generation unit and a data conversion unit 500. The random code generation unit may include a seed code generation section 100, a plurality of linear feedback shift registers, and a code combination section 400. In this exemplary embodiment, the plurality of linear feedback shift registers may include two linear feedback shift registers (LFSRs), a first linear feedback shift register 200 and a second linear feedback shift register 300. The number of linear feedback shift registers may vary depending on embodiments.

The semiconductor memory apparatus 12 may include a memory block having a plurality of memory cells. In this exemplary embodiment, it is assumed that the memory cell is a flash memory cell.

The seed code generation section 100 is configured to generate a plurality of seed codes having code values corresponding to input addresses ADDR<7:0>. In this exemplary embodiment, it is assumed that seed code generation section 100 generates a first seed code SEED_CODE1 and a second seed code SEED_CODE2, which have different code values from each other.

The first linear feedback shift register 200 is configured to receive the first seed code SEED_CODE1 as an initial value and generate a first random code RANDOM_CODE1 in response to a clock signal CLK. The second linear feedback shift register 300 is configured to receive the second seed code SEED_CODE2 as an initial value and generate a second random code RANDOM_CODE2 in response to the clock signal CLK.

Since the first linear feedback shift register 200 and the second linear feedback shift register 300 are configured to have different tab values from each other, the first random code RANDOM_CODE1 and the second seed code SEED_CODE2 have code values with different patterns from each other. Even if the first random code RANDOM_CODE1 is substantially identical to the second seed code SEED_CODE2, the first linear feedback shift register 200 and the second linear feedback shift register 300 have code values with different patterns from each other.

The code combination section 400 is configured to logically combine the first random code RANDOM_CODE1 with the second seed code SEED_CODE2 and generate a third, final random code RANDOM_CODE3. The code combination section 400 may include a logic section which performs an XOR operation on the first random code RANDOM_CODE1 and the second seed code SEED_CODE2 to generate the final random code RANDOM_CODE3.

Since the final random code RANDOM_CODE3 is generated through a combination of the first random code RANDOM_CODE1 and the second seed code SEED_CODE2, which have different patterns from each other, the final random code RANDOM_CODE3 has a more random pattern as compared with the first random code RANDOM_CODE1 or the second seed code SEED_CODE2.

The data conversion unit 500 is configured to convert input data INPUT_DATA<7:0> based on the final random code RANDOM_CODE3 and output conversion data OUTPUT_DATA<7:0>. The data conversion unit 500 may include a logic section which performs an XOR operation on the final random code RANDOM_CODE3 and the input data INPUT_DATA<7:0> to generate the conversion data OUTPUT_DATA<7:0>.

The semiconductor memory apparatus 12 is configured to program the conversion data OUTPUT_DATA<7:0> to a memory block at programming levels corresponding to the conversion data OUTPUT_DATA<7:0> provided from the memory controller 11.

The semiconductor system according to the exemplary embodiment generates the conversion data OUTPUT_DATA<7:0> using the final random code RANDOM_CODE3 having a more random pattern as compared with the conventional art, and programs the conversion data OUTPUT_DATA<7:0> to the memory block, so that programming levels are very randomly distributed. That is, the programming levels are randomly distributed in the row and column directions of memory cells arranged in a matrix form. Consequently, the occurrence probability of programming level patterns being highly erroneous is reduced. Furthermore, since the linear feedback shift register is used, the semiconductor system can be configured by a simple logic having a small area and is advantageous when the memory controller 11 restores data which is output from the semiconductor memory apparatus 12.

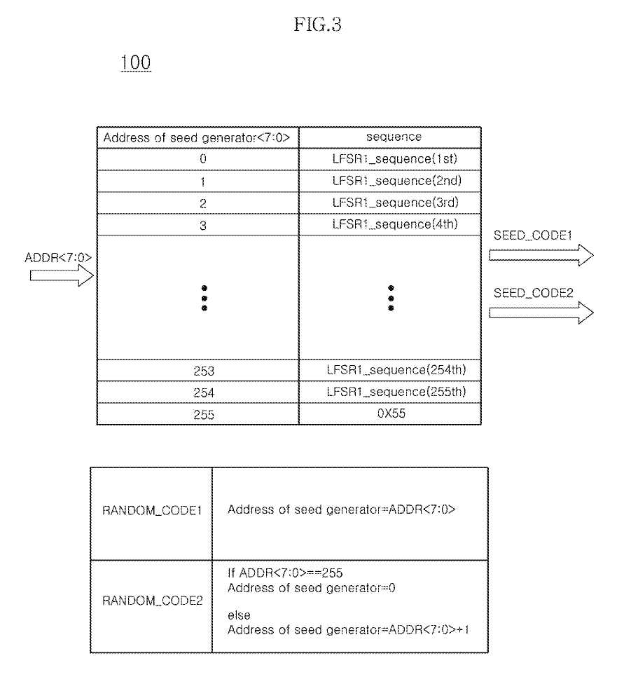

FIG. 3 is a schematic diagram of the seed code generation section illustrated in FIG. 2 according to the exemplary embodiment.

Referring to FIG. 3, the seed code generation section is configured to store a look up table having code values corresponding to the input addresses ADDR<7:0>. Here, the first seed code SEED_CODE1 is set to a code value assigned to the input addresses ADDR<7:0> and the second seed code SEED_CODE2 is set to a code value corresponding to a difference between the input addresses ADDR<7:0> and a constant offset address. The look up table may be stored using an internal storage block such as a ROM. The input addresses ADDR<7:0> may be defined as page addresses provide to the semiconductor memory apparatus 12.

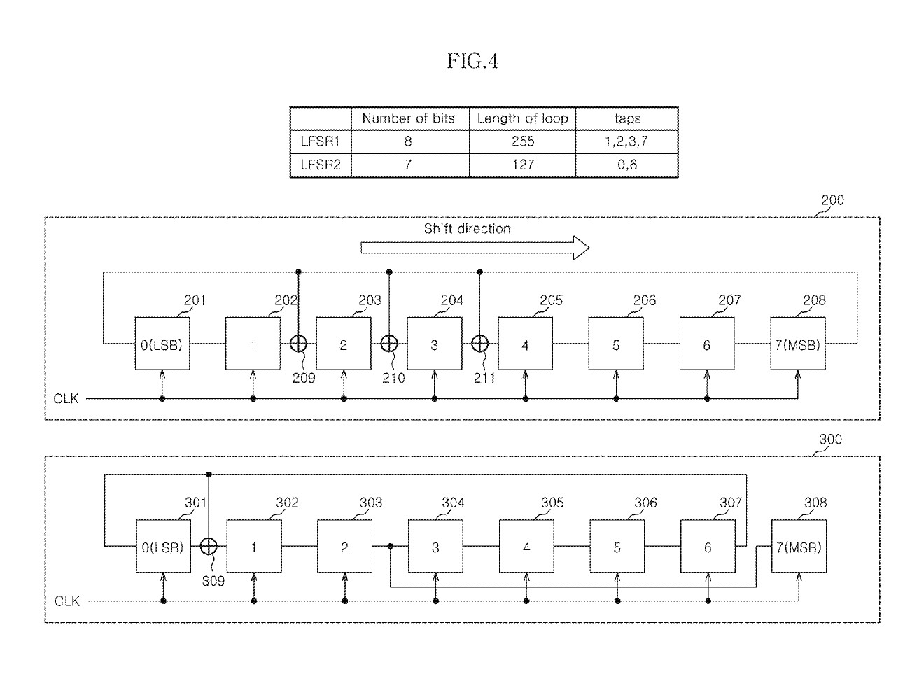

FIG. 4 is a configuration diagram of the first linear feedback shift register and the second linear feedback shift register illustrated in FIG. 2 according to the exemplary embodiment.

Referring to FIG. 4 the first linear feedback shift register 200 and the second linear feedback shift register 300 are configured to have tabs and lengths, which are different from each other, respectively.

The first linear feedback shift register 200 includes a plurality of flip-flops 201 to 208 and a plurality of operation sections 209 to 211. The plurality of flip-flops 201 to 208 are configured to shift stored codes in response to the clock signal CLK. The plurality of operation sections 209 to 211 are logics that perform an addition operation. The second linear feedback shift register 300 includes a plurality of flip-flops 301 to 308 and an operation section 309. The plurality of flip-flops 301 to 308 are configured to shift stored codes in response to the clock signal CLK. The operation section 309 is a logic that performs an addition operation.

The first linear feedback shift register 200 and the second linear feedback shift register 300 may be configured to invert a bit corresponding to a tab whenever a most significant bit (MSB) has a value of ‘1’ and shift a stored code whenever the most significant bit has a value of ‘0’. Furthermore, the first linear feedback shift register 200 and the second linear feedback shift register 300 are configured to output codes, which are obtained by shifting the initially input first seed code SEED_CODE1 and second seed code SEED_CODE1 once, as the initial first random code RANDOM_CODE1 and second random code RANDOM_CODE2. The first random code RANDOM_CODE1 output from the first linear feedback shift register 200 and the second random code RANDOM_CODE2 output from the second linear feedback shift register 300 are defined as signals output from the plurality of flip-flops.

As described above, the data programming method includes the steps of generating a plurality of random codes through a plurality of linear feedback shift registers receiving a plurality of seed codes as initial values, generating a final random code by logically combining the plurality of random codes with each other, generating conversion data by converting input data based on the final random code, and programming the conversion data at programming levels corresponding to the conversion data. The data programming method may further include a step of generating a plurality of seed codes having different code values from each other in correspondence with input addresses.

Furthermore, in the semiconductor system according to the exemplary embodiment as described above, the memory controller 11 includes the random code generation unit and the data conversion unit 500 and the semiconductor memory apparatus 12 is configured to program a memory block using the conversion data OUTPUT_DATA<7:0> provided from the data conversion unit 500 of the memory controller 11. Meanwhile, the semiconductor memory apparatus may include the random code generation unit and the data conversion unit 500 to directly generate the conversion data OUTPUT_DATA<7:0>.

So far, the exemplary embodiments of the present invention have been described in detail. For reference, embodiments including additional component elements, which are not directly associated with the technical spirit of the present invention, may be exemplified in order to describe the present invention in further detail. Since these embodiment changes have a large number of cases and can be easily inferred by those skilled in the art, the enumeration thereof will be omitted herein.

While certain embodiments have been described above, it will be understood to those skilled in the art that the embodiments described are by way of example only. Accordingly, a random code generation circuit, a semiconductor apparatus, a semiconductor system, and a data programming method described herein should not be limited based on the described embodiments. Rather, the random code generation circuit, the semiconductor apparatus, the semiconductor system, and the data programming method described herein should only be limited in light of the claims that follow when taken in conjunction with the above description and accompanying drawings.

What is claimed is:

1. A random code generation circuit comprising:
a seed code generation section configured to generate a plurality of seed codes having code values corresponding to input addresses;
a plurality of linear feedback shift registers configured to receive one of the plurality of seed codes as an initial value and generate respective random codes under a control of a clock signal; and
a code combination section configured to logically combine the plurality of random codes generated by the plurality of linear feedback shift registers and generate a final random code.

2. The random code generation circuit according to claim 1, wherein the plurality of seed codes have code values different from each other.

3. The random code generation circuit according to claim 1, wherein the seed code generation section is configured to store a look up table having code values corresponding to the input addresses, and the plurality of seed codes are set to code values corresponding to different offset addresses from each other when being set to code values assigned to the input addresses.

4. The random code generation circuit according to claim 1, wherein the plurality of linear feedback shift registers are configured to have different tabs.

5. The random code generation circuit according to claim 1, wherein the code combination section includes a logic section configured to perform an XOR operation on the plurality of random codes to generate the final random code.

6. A semiconductor apparatus comprising:
a plurality of linear feedback shift registers configured to receive a plurality of seed codes as initial values and generate respective random codes under a control of a clock signal;
a code combination section configured to logically combine the plurality of random codes generated by the plurality of linear feedback shift registers and generate a final random code; and
a data conversion unit configured to convert input data based on the final random code and output conversion data.

7. The semiconductor apparatus according to claim 6, further comprising:
a memory block configured to program the conversion data at programming levels corresponding to the conversion data.

8. The semiconductor apparatus according to claim 7, wherein the memory block includes a plurality of flash memory cells.

9. The semiconductor apparatus according to claim 6, further comprising:
a seed code generation section configured to generate the plurality of seed codes having code values corresponding to input addresses.

10. The semiconductor apparatus according to claim 9, wherein the plurality of seed codes have different code values from to each other.

11. The semiconductor apparatus according to claim 9, wherein the seed code generation section is configured to store a look up table having code values corresponding to the input addresses, and the plurality of seed codes are set to code values corresponding to different offset addresses from each other when being set to code values assigned to the input addresses.

12. The semiconductor apparatus according to claim 6, wherein the plurality of linear feedback shift registers are configured to have different tabs from each other.

13. The semiconductor apparatus according to claim 6, wherein the code combination section includes a logic section configured to perform an XOR operation on the plurality of random codes to generate the final random code.

14. The semiconductor apparatus according to claim 6, wherein the data conversion unit comprises a logic section which performs an XOR operation on the final random code and the input data to generate the conversion data.

15. A semiconductor system including a memory controller and a semiconductor memory apparatus, wherein the memory controller comprises:
a plurality of linear feedback shift registers configured to receive a plurality of seed codes as initial values and generate respective random codes under a control of a clock signal;
a code combination section configured to logically combine the is plurality of random codes generated by the plurality of linear feedback shift registers and generate a final random code; and
a data conversion unit configured to convert input data based on the final random code and output conversion data,
wherein the semiconductor memory apparatus is configured to program the conversion data provided from the memory controller at programming levels corresponding to the conversion data.

16. The semiconductor system according to claim 15, wherein the plurality of seed codes have different code values from each other.

17. The semiconductor system according to claim 15, wherein the memory controller further comprises:
a seed code generation section configured to generate the plurality of seed codes having code values corresponding to input addresses.

18. The semiconductor system according to claim 17, wherein the seed code generation section is configured to store a look up table having code values corresponding to the input addresses, and the plurality of seed codes are set to code values corresponding to different offset addresses from each other when being set to code values assigned to the input addresses.

19. The semiconductor system according to claim 15, wherein the plurality of linear feedback shift registers are configured to have different tabs from each other.

20. The semiconductor system according to claim 15, wherein the code combination section includes a logic section configured to perform an XOR operation on the plurality of random codes to generate the final random code.

21. The semiconductor system according to claim 15, wherein the data conversion unit includes a logic section which performs an XOR operation on the final random code and the input data to generate the conversion data.

22. The semiconductor system according to claim 15, wherein the semiconductor memory apparatus includes a plurality of flash memory cells.

23. A data programming method comprising the steps of:
generating a plurality of random codes through a plurality of linear feedback shift registers receiving a plurality of seed codes as initial values, respectively;
generating a final random code by logically combining the plurality of random codes with each other;
generating conversion data by converting input data based on is the final random code; and
programming the conversion data at programming levels corresponding to the conversion data.

24. The data programming method according to claim 23, further comprising the step of:
generating the plurality of seed codes have different code values from each other in correspondence with input addresses.

25. The data programming method according to claim 24, wherein the plurality of seed codes are set to code values corresponding to different offset addresses from each other when being set to code values of a look up table which are assigned to the input addresses.

26. The data programming method according to claim 23, wherein the step of generating the conversion data includes the step of:
performing an XOR operation on the final random code and the input data.
